(19) United States
(12) Patent Application Publication
(10) Pub. No.: US 2009/0313270 A1
(43) Pub. Date: Dec. 17, 2009

(54) SEMANTIC FRAME STORE

(75) Inventors: Brian Aust, Redmond, WA (US); Chris Demetrios Karkanias, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/141,067

(22) Filed: Jun. 17, 2008

(51) Int. Cl. G06F 17/00

(52) U.S. Cl. 707/100; 707/E17.044

(57) ABSTRACT

A semantic frame store system including a semantic frame store configured to provide representation of data items in a semantic frame schema having a plurality of tables. The semantic frame store system and semantic frame store are configured to enable a conceptual structure of the data items to be changed without requiring alteration to the semantic frame schema.

### BACKGROUND

Structured information stores commonly employ computerized spreadsheets or conventional relational databases with fixed schema to store data. These storage mechanisms are employed to great advantage in a variety of settings. Nonetheless, certain static properties of such storage mechanisms can place burdens on scientific inquiry and other pursuits that involve exploration and study of new concepts. Typically, when new concepts require relational storage, schema are modified and data often migrated from the old structure to the new. Schema modification and data migration can be relatively expensive and slow, inhibiting the tasks of inquiry, analysis, experimentation, etc.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A semantic frame store is provided, in which data items may be represented in a semantic frame schema. The semantic frame schema and information store are configured to permit modification of a conceptual structure of the data items without requiring changes to the semantic frame schema.

According to one aspect, the semantic frame schema leverages frame-based techniques and provides one or more class tables, one or more class member tables, one or more class instance tables, and one or more property value tables. The tables of the semantic frame schema may be easily manipulated to change the underlying conceptual structure of the data items without requiring potentially burdensome schema changes.

### BRIEF DESCRIPTION OF THE DRAWINGS

FIG. 1 schematically depicts a computing system running a semantic frame store system according to the present description.

FIGS. 2-5 depict exemplary aspects of a semantic frame schema according to the present description.

FIGS. 6A and 6B depict an exemplary relational schema.

FIG. 7 depicts an example of a semantic frame store method according to the present description.

### DETAILED DESCRIPTION

The present description provides for a system and method for managing an information store of data items. In the present examples, a given collection of data items may be considered to have a conceptual structure capable of representation in a relational data store, such as a relational database. Typical representations of conceptual structures employ database schema having tables and column definitions, with individual concepts being described in individual tables.

For example, three tables could be employed to describe aspects of a university: “Student,” “Faculty” and “Department.” In this example, each table relates to a concept relevant to the university setting. Column definitions for the “Student” and/or “Faculty” tables might include “Name,” “Social Security #,” “date of birth,” “address,” etc. The entries (rows) on these tables would correspond to specific students or faculty members (e.g., Lisa, Henry, Chris, Professor Williams, etc.). Column definitions for the “Department” table could include “Department Name,” “Department Chair,” etc.

In the above example setting, the column entries may be used to establish relationships between the tables. For example, the “Department” table could have a row entry for the “English Department” and identify that the “Department Chair” is “Professor Williams” (a faculty member). A link is thus established between the “Faculty” table and the “Department” table. This type of link or relationship is commonly employed in relational stores.

Continuing with the above example, the addition of row entries to the described tables does not alter the conceptual structure of the data in the store. Rather, the addition of row entries simply builds out the existing conceptual structure: students or faculty members are added to or removed from the list; addresses are updated; new university departments are created; etc.

To add new concepts relevant to the university setting, or to capture different information about existing concepts (i.e., to alter the conceptual structure of the store), the schema in the above example are modified. In other words, new tables need to be added, and/or new columns are defined for the existing tables.

The present system and method provide for a semantic frame store which, in one aspect, allows for creation and modification of conceptual structures without requiring schema changes. The semantic frame store is configured such that data items are represented in a semantic frame schema having a plurality of tables. Row entries in the tables describe both the conceptual structure of the stored data items and instances of that structure. Accordingly, new tables or column definitions (schema changes) are not required to modify the conceptual structure. Changes to the conceptual structure may be effected simply through addition of rows to the existing tables. Dynamic and easy end-user manipulation of the conceptual structure allows for easy absorption of new concepts into the data store.

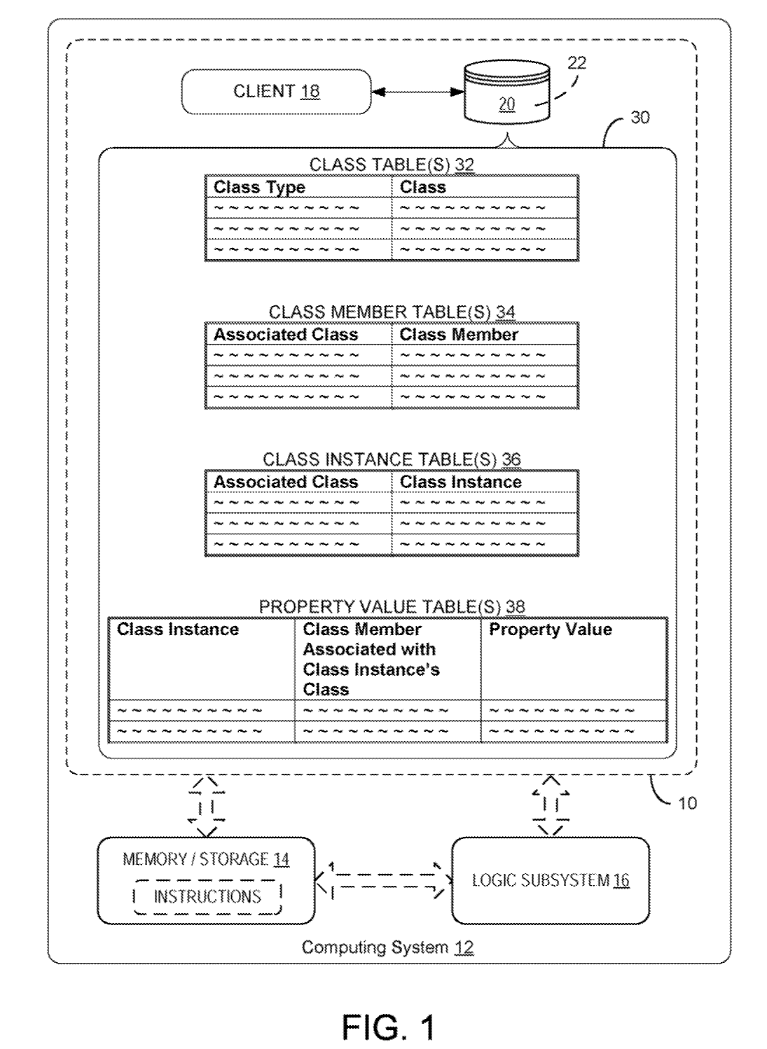

FIG. 1 schematically shows a nonlimiting example embodiment of a semantic frame store system 10 according to the present description. In particular, FIG. 1 schematically shows a computing system 12 that includes memory/storage 14 and logic subsystem 16 for running semantic frame store system 10.

Logic subsystem 16 may be configured to execute one or more instructions, including instructions responsible for providing the herein described semantic frame store functionality. For example, the logic subsystem may be configured to execute one or more instructions that are part of one or more programs, routines, objects, components, data structures, or other logical constructs. Such instructions may be implemented to perform a task, implement an abstract data type, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Memory/storage 14 may include one or more devices configured to hold instructions that, when executed by the logic subsystem, cause the logic subsystem to implement the herein described methods and processes. Memory/storage 14 may include volatile portions and/or nonvolatile portions. In some embodiments, memory/storage 14 may include two or more different devices that may cooperate with one another to hold instructions for execution by the logic subsystem. In some embodiments, logic subsystem 16 and memory/storage 14 may be integrated into one or more common devices and/or computing systems.

Semantic frame store system 10 includes a client 18 operatively coupled with a semantic frame store 20 that is configured to store a plurality of data items 22. In the examples described herein, data items 22 have a conceptual structure capable of description and definition through multiple different schemas.

Semantic frame store 20 is configured to provide representation of the data items in a semantic frame schema 30 having a plurality of tables. As indicated, the plurality of tables may include a class table 32, class member table 34, class instance table 36 and property value table 38. In some embodiments, the semantic frame schema may include more than one of the different tables.

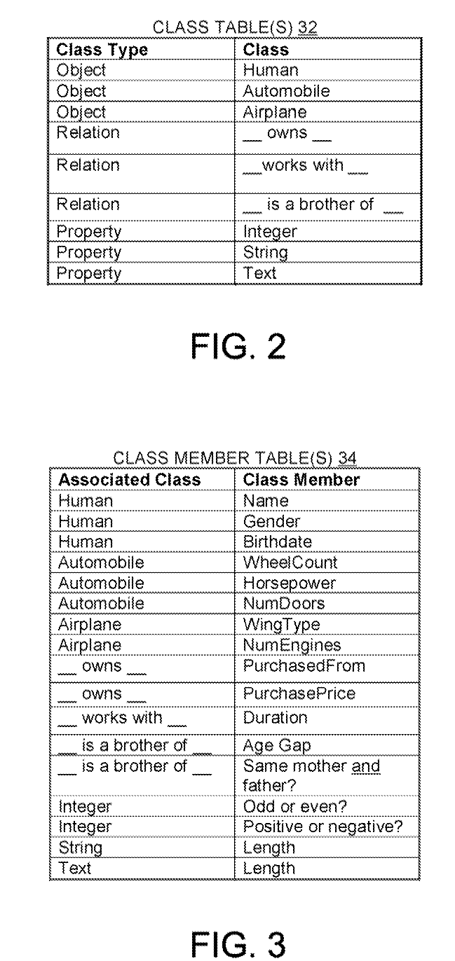

Referring to FIG. 1 and FIG. 2, the items included on class table 32 are classes. A “class” may be thought of as a “type” or “category” of something. For example, each employee in the set of all Microsoft employees is of the type “Human” and therefore of the type “Mammal.” “Human” and “Mammal” are sub-classes of “Living Organisms.” Each Microsoft employee is an instance of each of these three classes. Likewise, “Airplane” is a class of which “Spirit of St. Louis” is an instance.

Classes often exist in a hierarchy expressing generalization and specialization across sets of classes. For example, the progression “Animal”->“Mammal”->“Human” is one potential class hierarchy with “Animal” being the most general and “Human” being the most specific. In this illustration we say that “Mammal” inherits (or derives) from “Animal” and “Human” inherits from “Mammal.” As will be explained in more detail, classes of the present description may be of varying types, including object classes (types of objects), relation classes (types of relationships) and property classes (types of properties). FIG. 2 provides a number of different exemplary classes and their associated class types.

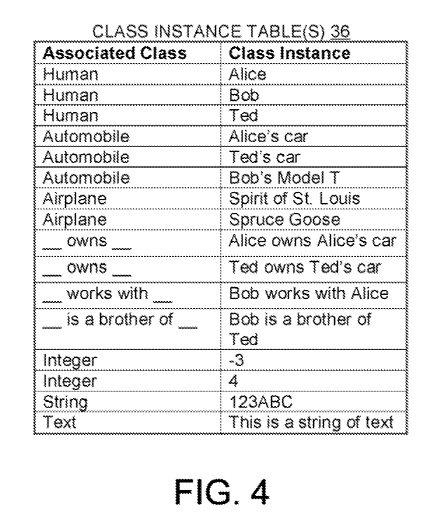

Referring to FIG. 1 and FIG. 3, the items included on class member table 34 are class members. As shown in the various examples of FIG. 3, one or more class members are associated with each of the classes. A member of a class is a property that instances of that class may express as a property value. For example, the “Human” class has a “Gender” member by which instances of that class may express their male/female gender. The class “Airplane” does not have an associated “Gender” class member so instances of class “Airplane” may not express a male/female Gender value. Instead, class members such as “WingType” and “NumEngines” are associated with the class “Airplane.” These class members permit description of particular airplanes to be described in terms of what type of wings and the number of engines they have.

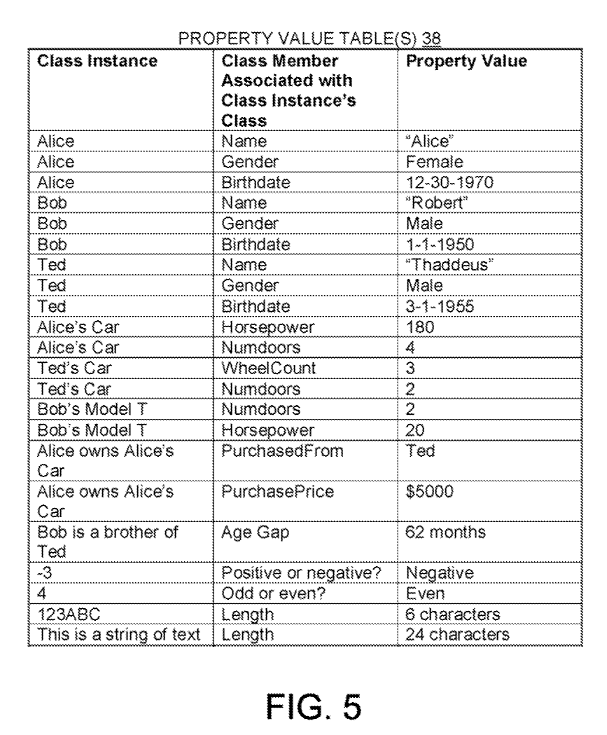

Referring to FIG. 1 and FIG. 4, the items included on class instance table 36 are class instances. As shown in the various examples of FIG. 4, one or more of class instances are associated with each of the classes, and provide a particular example of that class. Instances of the object class “Human” include “Alice,” Bob” and “Ted”; instances of the object class “Automobile” include “Alice's car,” Ted's car” and “Bob's Model T”; and so on.

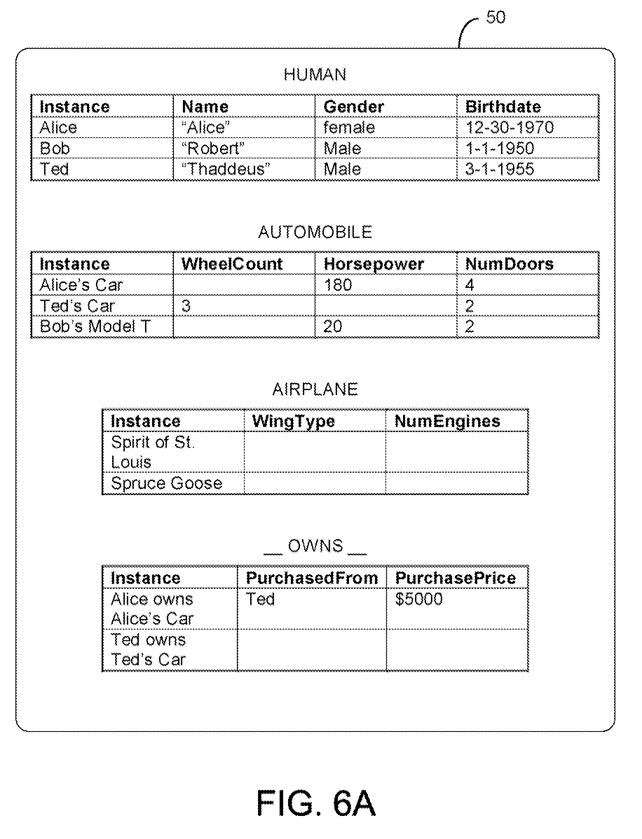

Referring to FIG. 1 and FIG. 5, the items included on property value table 38 are property values for the class instances. In the conventional schema of relational databases, these are the specific entries (column entries) for the rows of the relational tables or, in the parlance of spreadsheets, the individual “cells” of a sheet. The property value for a class instance specifies a value for one of the class members that are associated with the class to which that instance belongs. For example, “Bob is a brother of Ted” is an instance of the relation class “_ is a brother of _” (FIG. 4). An expressible property of sibling relationships is “Age Gap,” as shown on class member table 34 (FIG. 3). For this particular example (instance) of a sibling relationship (i.e., Bob and Ted), the value of the “Age Gap” class member is 62 months. In other words, Bob and Ted are siblings, and their difference in age is 5 years and 2 months.

Particular discussion of additional examples may be instructive. FIG. 2 (class table 32) includes “Integer” and other example property classes. As discussed above, a class is a “type” of something. Accordingly, “Integer” is a type of property. FIG. 3 (class member table 34) specifies an “Odd or even?” class member for “Integer,” reflecting that “oddness” or “evenness” is a property (characteristic) that instances of the “Integer” property class may express. For the integer instance “4,” the value of the oddness/evenness characteristic is “Even,” as shown in FIG. 5. “Alice owns Alice's car” is an instance of the relation class “_ owns _,” which reflects the concept of ownership (e.g., humans owning automobiles). A potential characteristic/property of an ownership relation is that the thing that is owned was purchased for a particular price, as indicated by the “PurchasePrice” class member of FIG. 3. Here, the value is shown on FIG. 5 as “$5,000.” In other words, Alice bought her car for $5,000.

Semantic frame store 20 and semantic frame schema 30 may be advantageously employed to facilitate storage and semantic analysis of semantic information. More particularly, the information store may be used to model predicate logic triples (subject-predicate-object) in connection with semantic regimes such as RDF (Resource Description Framework), RDFS (Resource Description Framework Schema), OWL (Web Ontology Language) and the like. In particular, the following predicate logic semantic inputs could serve as a basis for some of the above-described examples:

| Subject | Predicate | Object |
|---|---|---|
| Bob | is a | human |
| Bob | is a | male |
| Bob | legal name is | Robert |
| Bob | is the brother of | Ted |
| The alphanumeric string | has a length of | 6 characters |
| “123ABC” | | |

In some settings, client 18 may be adapted to provide an interface for receiving semantic inputs and converting them into data items to be represented in semantic frame schema 30. The combined leveraging of frame-based and relational storage described herein can provide particular advantages when using semantic frame store system 10 for semantic storage and analysis. As described below, the extensibility of the data store can permit easy capturing of complex semantic statements about new concepts. Furthermore, though the structure is flexible, the semantic frame schema may be nonetheless configured to take advantage of high performance relational indexed queries.

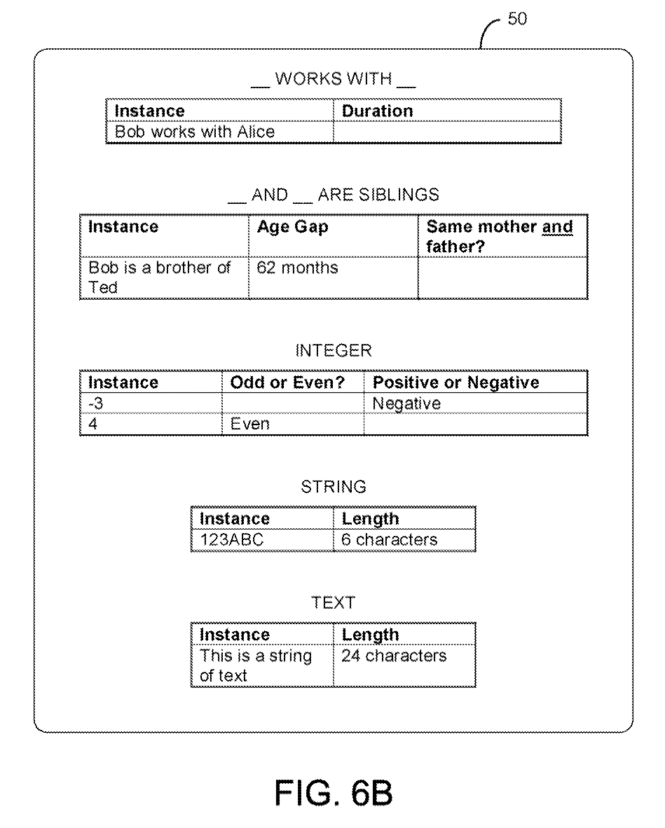

From the foregoing discussion, it will be apparent that the conceptual structure of data items 22 is independent of the schema of the information store in which it resides. Indeed, the exemplary data items and conceptual structure in the semantic frame schema of FIGS. 2-5 may be alternately described in a conventional relational schema, such as the relational schema 50 shown in FIGS. 6A and 6B.

FIGS. 6A and 6B show the same data items and accompanying conceptual structure of the examples of FIGS. 2-5, though with a different schema. Specifically, the table and column definitions of relational schema 50 are different from those employed in connection with semantic frame schema 30. In particular, relational schema 50 includes a separate table for each of the “Human,” “Automobile,” etc. classes. This schema and approach is of the type commonly employed in conventional relational databases. Each concept or idea is represented by a table, instances of the concept appear as row entries in the table, and property values are indicated in the particular column entries (cells) of each row.

The nature and design of relational schema 50 is such that adding rows to any of the tables has the effect of instantiating, but not modifying, the underlying conceptual structure of the data. In other words, row insertions do not alter the framework of the information in the store. The concept list (“Human,” “Automobile,” etc.) and expressible properties (“Name,” “Horsepower,” etc.) are not affected by row insertions. Schematic alterations are employed to alter the conceptual structure.

For example, to capture the idea that certain physical objects owned by humans can be insured against loss/damage would require significant schematic changes to the example of FIGS. 6A and 6B. Additional tables would be needed for concepts such as insurance companies, insurance policies, etc. Additional columns would need to be added to the “Automobile” and “Airplane” tables to indicate that specific cars or airplanes were insured, the identity of the insurance company or companies, the amount of coverages, etc.

In contrast, semantic frame store system 10 is configured to permit modification of the represented conceptual structure without requiring schematic changes. In particular, semantic frame schema 30 is defined such that adding rows to one or more of the schema tables produces a change in the underlying conceptual structure of the information store. As previously discussed, the rows of semantic frame schema describe the conceptual structure of the data in addition to instances of that structure.

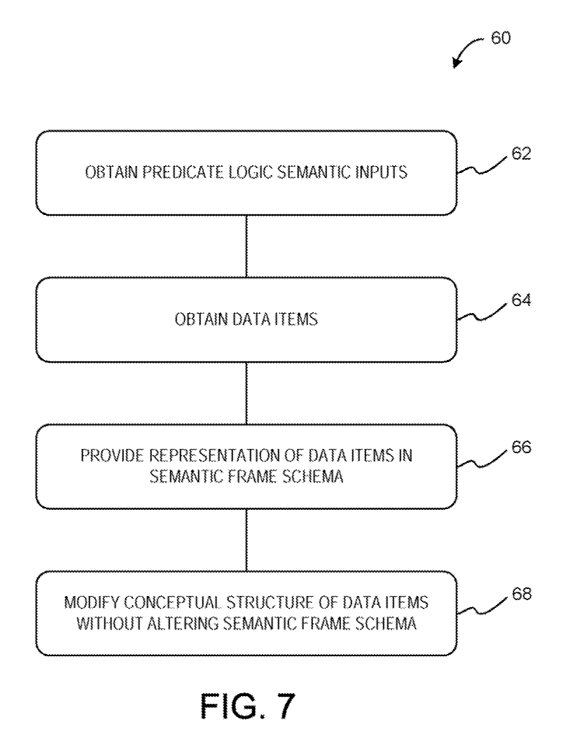

Referring now to FIG. 7, an example semantic frame store method 60 is depicted. As shown at 62, the method may include receiving or otherwise obtaining predicate logic semantic inputs. For example, as discussed above, semantic inputs such as “Bob is a brother of Ted” may be modeled in the semantic frame store via various data items. These semantic inputs may be received and/or generated by client 18 and supplied to semantic frame store 20.

As shown at 64, method 60 may further include deriving or otherwise obtaining specific data items from the predicate logic semantic inputs. For example, various semantic inputs may provide the basis for populating the store with data items relating to “Bob,” such as his birthdate, family relationships, vehicles, etc.

Regardless of whether the depicted method is employed in connection with predicate logic or other semantic constructs, the method may include representing data items in a semantic frame schema, as shown at 66. As previously described, the semantic frame schema may include one or more class tables (e.g., class tables 32) and one or more class member tables (e.g., class member tables 34). The semantic frame schema employed at 66 may further include one or more class instance tables and one or more property value tables, as described in the examples above.

At 68, the method may further include modifying a conceptual structure of the data items while maintaining the semantic frame schema. This modification of the conceptual structure may include adding rows to the tables of the semantic frame schema, as discussed in the above examples. Specifically, changes to the conceptual structure of the data items may be effected through adding rows to the class table(s) and/or class member table(s).

In addition to facilitating extensibility of stored data, the exemplary systems and methods herein may also provide efficient query performance. Although the described semantic frame schema differs in many respects from conventional relational regimes, relational aspects may still be employed in example embodiments, allowing applications to make use of high performance relational indexed queries.

It will be appreciated that the computing devices described herein may be any suitable computing device configured to execute the programs described herein. For example, the computing devices may be a mainframe computer, personal computer, laptop computer, portable data assistant (PDA), computer-enabled wireless telephone, networked computing device, or other suitable computing device, and may be connected to each other via computer networks, such as the Internet. These computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A semantic frame store system, comprising:
a semantic frame store configured to provide representation of data items in a semantic frame schema having a plurality of tables, the plurality of tables including:
one or more class tables, where items on the one or more class tables are classes;
one or more class member tables, where items on the one or more class member tables are class members, where one or more of the class members are associated with each of the classes, and where association of a given one of the class members with a given one of the classes identifies an available property for that class;
one or more class instance tables, where items on the one or more class instance tables are class instances, where one or more of the class instances are associated with each of the classes, and where association of a given one of the class instances with a given one of the classes identifies a particular example of that class; and
one or more property value tables, where items on the one or more property value tables are property values for the class instances, and where a property value for a given one of the class instances specifies a value for one of the class members that are associated with the class to which that class instance belongs.

2. The semantic frame store system of claim 1, further comprising a client operatively coupled with the semantic frame store and configured to enable modification of a conceptual structure of the semantic frame store while maintaining the semantic frame schema.

3. The semantic frame store system of claim 2, where said modification of the conceptual structure of the semantic frame store is performed by adding one or more rows to one or more of the plurality of tables of the semantic frame schema.

4. The semantic frame store system of claim 3, where said modification of the conceptual structure of the semantic frame store is performed by adding one or more rows to the one or more class tables.

5. The semantic frame store system of claim 3, where said modification of the conceptual structure of the semantic frame store is performed by adding one or more rows to the one or more class member tables.

6. The semantic frame store system of claim 3, where said modification of the conceptual structure of the semantic frame store is performed by adding one or more rows to the one or more class tables and adding one or more rows to the one or more class member tables.

7. The semantic frame store system of claim 1, further comprising a client operatively coupled with the semantic frame store and configured to receive predicate logic semantic inputs, where the data items represented by the semantic frame store are based on the predicate logic semantic inputs.

8. The semantic frame store system of claim 1, where the classes on the one or more class tables include object classes.

9. The semantic frame store system of claim 1, where the classes on the one or more class tables include property classes.

10. The semantic frame store system of claim 1, where the classes on the one or more class tables include relation classes.

11. A semantic frame store method, comprising:
receiving a plurality of predicate logic semantic inputs;
modeling the predicate logic semantic inputs in a semantic frame store so as to provide representation of the predicate logic semantic inputs as data items in a semantic frame schema having a plurality of tables, the plurality of tables including:
one or more class tables, where items on the one or more class tables are classes;
one or more class member tables, where items on the one or more class member tables are class members, where one or more of the class members are associated with each of the classes, and where association of a given one of the class members with a given one of the classes identifies an available property for that class;
one or more class instance tables, where items on the one or more class instance tables are class instances, where one or more of the class instances are associated with each of the classes, and where association of a given one of the class instances with a given one of the classes identifies a particular example of that class; and
one or more property value tables, where items on the one or more property value tables are property values for the class instances, and where a property value for a given one of the class instances specifies a value for one of the class members that are associated with the class to which that class instance belongs.

12. The method of claim 11, further comprising modifying a conceptual structure of the data items while maintaining the semantic frame schema.

13. The method of claim 12, where modifying the conceptual structure of the semantic frame store includes adding one or more rows to one or more of the plurality of tables.

14. The method of claim 13, where modifying the conceptual structure of the semantic frame store includes adding one or more rows to the one or more class tables.

15. The method of claim 13, where modifying the conceptual structure of the semantic frame store includes adding one or more rows to the one or more class member tables.

16. The method of claim 13, where modifying the conceptual structure of the semantic frame store includes adding one or more rows to the one or more class tables and adding one or more rows to the one or more class member tables.

17. A semantic frame store method, comprising:
receiving a plurality of data items, said data items having a conceptual structure that is representable in a relational schema including a plurality of tables which each have one or more column definitions, and where in such relational schema the data items include specific column values for row entries of the plurality of tables;
using a semantic frame store to store the data items and to describe and enable modification of the conceptual structure; said semantic frame store having and semantic frame schema including:
one or more class tables, where the plurality of tables of the conceptual structure are identified by row entries of the one or more class tables; and
one or more class member tables; where the one or more column definitions of the plurality of tables of the conceptual structure are identified by row entries of the one or more class member tables;
receiving additional data items; and
modifying the conceptual structure to accommodate receipt of the additional data items in the semantic frame store, said modifying being performed without alteration of the semantic frame schema.

18. The method of claim 17, where said modifying the conceptual structure to accommodate receipt of the additional data items in the semantic frame store includes adding one or more rows to the one or more class tables.

19. The method of claim 17, where said modifying the conceptual structure to accommodate receipt of the additional data items in the semantic frame store includes adding one or more rows to the one or more class member tables.

20. The method of claim 17, further comprising basing the plurality of data items on predicate logic semantic inputs.
